(19) United States
(12) Patent Application Publication
(10) Pub. No.: US 2021/0372798 A1
(43) Pub. Date: Dec. 2, 2021

(54) VISUAL NAVIGATION METHOD AND SYSTEM FOR MOBILE DEVICES BASED ON QR CODE SIGNPOSTS

(71) Applicant: PEKING UNIVERSITY, Beijing (CN)

(72) Inventors: Kaigui Bian, Beijing (CN); Yuanxing Zhang, Beijing (CN); Kangle Deng, Beijing (CN); Zilong Wang, Beijing (CN); Yue Wang, Beijing (CN)

(21) Appl. No.: 17/150,663

(22) Filed: Jan. 15, 2021

(30) Foreign Application Priority Data
May 29, 2020 (CN) 202010474756.5

(51) Int. Cl. G01C 21/20; G06K 7/14; G01C 21/00

(52) U.S. Cl. CPC G01C 21/206; G06K 7/1443; G01C 21/005; G06K 7/1417

(57) ABSTRACT

The present disclosure provides a visual navigation method and system for mobile devices based on QR code signposts. The visual navigation method for movement includes: autonomously planning an optimal route according to a destination specified by a user, performing positioning in an image captured by a trolley camera and recognizing signpost information, and adjusting a pose according to the signpost information and going to a signpost in the path. In this process, positioning is performed in real time and route planning is updated, and a user may change the destination at any time in a trolley navigation process according to a robust anomaly recovery decision. The method disclosed by the present disclosure not only proposes an indoor navigation solution that does not rely on a GPS signal and strong computation resources, but also can effectively meet an indoor scheduling scenario in which a path needs to be planned intelligently.

### TECHNICAL FIELD

The present disclosure relates to the technical field of visual navigation for movement, and in particular, to a visual navigation method and system for mobile devices based on QR code signposts.

### BACKGROUND

A navigation technology is the key to implementing autonomous movement and intelligent behaviors of mobile robots, and has a broad application prospect. Currently, many autonomous navigation technologies or devices are based on global positioning system (GPS) technologies, and perform navigation by means of GPS signals. In an indoor scenario, GPS signal strength is attenuated seriously, which makes a GPS-based navigation system ineffective. Therefore, a vision-based navigation system is necessary for various indoor scheduling scenarios.

Currently, indoor navigation technologies can be roughly divided into three categories according to used signals: (1) Vision-based and infrared image processing technology, which has relatively low stability. (2) Dead reckoning technology based on an inertial measurement unit such as an accelerometer, which has accumulated errors and easily causes a large deviation. (3) Positioning and navigation technology based on a wireless signal such as Zigbee or Wi-Fi, which usually requires relatively high arrangement and maintenance costs because a signal network needs to be constructed indoors, a signal source location needs to be measured, and the like.

To resolve the foregoing problems, there are some vision-based methods using a QR code as a signpost in the prior art. In some methods, there shall be a vertical relationship between an optical axis direction of a camera and the ground on which a QR code is laid, and a distance between the camera and the ground needs to be very short. The ground needs to be extremely clean. Once a lens is polluted by stains such as dust, a recognition rate of a QR code signpost and navigation accuracy are greatly affected. According to an indoor autonomous navigation method based on monocular vision and QR code signpost provided in the patent (CN106969766), the foregoing problem that the camera needs to be placed close to the ground is resolved. However, in the proposed method, the QR code signpost includes direction information. It can be considered that a navigation route is partially determined after the QR code signpost is laid. That is, in this method, a robot (trolley) can only move along a pre-determined route, but cannot autonomously plan a route. Once a moving route needs to be changed on a large scale (for example, driving is performed in an opposite direction of an original route), a signpost needs to be re-laid. This greatly limits an application scenario of this method, and increases maintenance costs. In addition, this method is not applicable to indoor intelligent scheduling scenario in which a path needs to be autonomously planned.

### SUMMARY

The present disclosure aims to provide a visual navigation method and system for mobile devices based on QR code signposts, to resolve a problem that in an existing indoor autonomous navigation method based on monocular vision and QR code signpost, a route cannot be autonomously planned, leading to a limited application scenario and high maintenance costs.

To achieve the above purpose, the present disclosure provides the following technical solutions.

A visual navigation method for mobile devices based on QR code signposts includes:

obtaining a QR code signpost map of a plurality of QR code signposts laid indoors;

obtaining a current location of a trolley and a destination specified by a user;

determining whether the current location is consistent with the destination, to obtain a first determining result;

ending navigation if the first determining result is that the current location is consistent with the destination;

if the first determining result is that the current location is inconsistent with the destination, automatically planning an optimal route from the current location to the destination according to the current location, the destination, and the QR code signpost map;

determining, according to the current location and the optimal route, that a next QR code signpost that the trolley is to go to is a destination signpost, obtaining a signpost code of the destination signpost, and using the signpost code as a target code;

obtaining a current image captured by a trolley camera;

detecting a QR code signpost according to the current image, and determining, according to the target code, whether the QR code signpost is detected successfully, to obtain a second determining result;

if the second determining result is that the QR code signpost is detected successfully, adjusting a direction of the trolley according to a relative location of the QR code signpost in the current image, so that the trolley faces the QR code signpost and goes forward;

in a process in which the trolley goes forward, obtaining brightness information captured by an infrared sensor installed under the trolley;

determining, according to the brightness information, whether the trolley reaches the QR code signpost, to obtain a fourth determining result;

if the fourth determining result is that the trolley reaches the QR code signpost, returning to the step of obtaining a current location of a trolley and a destination specified by a user;

if the fourth determining result is that the trolley does not reach the QR code signpost, returning to the step of adjusting a direction of the trolley according to a relative location of the QR code signpost in the current image, so that the trolley faces the QR code signpost and goes forward; and

if the second determining result is that the QR code signpost is detected unsuccessfully, determining, by using an anomaly recovery decision method, a manner in which the trolley goes forward.

Optionally, the automatically planning an optimal route from the current location to the destination according to the current location, the destination, and the QR code signpost map specifically includes:

performing a depth-first search on the QR code signpost map, to determine a plurality of routes from the current location to the destination, and record a quantity of turns and a route distance that are of each route; and

determining that a route in the plurality of routes that has a smallest quantity of turns and a shortest route distance is the optimal route.

Optionally, the detecting a QR code signpost according to the current image, and determining, according to the target code, whether the QR code signpost is detected successfully, to obtain a second determining result specifically includes:

detecting the QR code signpost according to the current image, where if the QR code signpost exists in the current image, a signpost code of the QR code signpost can be detected, and the signpost code is consistent with the target code, the second determining result is that the QR code signpost is detected successfully; or otherwise, the second determining result is that the QR code signpost is detected unsuccessfully.

Optionally, the adjusting a direction of the trolley according to a relative location of the QR code signpost in the current image, so that the trolley faces the QR code signpost and goes forward specifically includes:

performing binarization processing on the current image, to generate a binary image;

performing contour detection processing on the binary image, to obtain a plurality of contours in the current image;

performing polygonal approximation processing on the plurality of contours, to obtain shapes of the plurality of contours;

removing a non-quadrilateral contour in the plurality of contours according to the shapes of the contours, to obtain a plurality of quadrilateral contours;

filtering the plurality of quadrilateral contours according to areas of the quadrilateral contours, to obtain a QR code signpost contour;

scanning a QR code signpost in the QR code signpost contour, to obtain a signpost code of the QR code signpost;

determining location coordinates of four vertices of the QR code signpost contour in the current image;

determining horizontal coordinates of a center of gravity of the QR code signpost according to the location coordinates of the four vertices in the current image;

obtaining horizontal coordinates of an image center of the current image; and

adjusting the direction of the trolley according to a relative location of the horizontal coordinates of the center of gravity of the QR code signpost to the horizontal coordinates of the image center, so that the trolley faces the QR code signpost and goes forward.

Optionally, the determining, by using an anomaly recovery decision method, a manner in which the trolley goes forward specifically includes:

detecting a QR code signpost according to the current image, and determining whether a QR code signpost exists in the current image, to obtain a fifth determining result;

if the fifth determining result is that no QR code signpost exists in the current image, controlling the trolley to go forward by searching a path in a zigzag in a heuristic manner, to find a nearby QR code signpost;

if the fifth determining result is that a QR code signpost exists in the current image, determining whether a signpost code of the QR code signpost can be recognized, to obtain a sixth determining result;

if the sixth determining result is that the signpost code of the QR code signpost cannot be recognized, returning to the step of adjusting a direction of the trolley according to a relative location of the QR code signpost in the current image, so that the trolley faces the QR code signpost and goes forward;

if the sixth determining result is that the signpost code of the QR code signpost can be recognized, determining whether the signpost code is consistent with the target code, to obtain a seventh determining result;

if the seventh determining result is that the signpost code is inconsistent with the target code, determining whether a reserved chance to correct an incorrect destination signpost is exhausted, to obtain an eighth determining result;

if the eighth determining result is that the reserved chance to correct an incorrect destination signpost is not exhausted, adjusting the direction of the trolley according to a location of the QR code signpost in the QR code signpost map, so that the trolley faces the destination signpost and goes forward; and

if the eighth determining result is that the reserved chance to correct an incorrect destination signpost is exhausted, returning to the step of adjusting a direction of the trolley according to a relative location of the QR code signpost in the current image, so that the trolley faces the QR code signpost and goes forward; and

if the seventh determining result is that the signpost code is consistent with the target code, determining that the second determining result is that the QR code signpost is detected successfully.

A visual navigation system for mobile devices based on QR code signposts includes:

a QR code signpost map obtaining module, configured to obtain a QR code signpost map of a plurality of QR code signposts laid indoors;

a location information obtaining module, configured to obtain a current location of a trolley and a destination specified by a user;

a location determining module, configured to determine whether the current location is consistent with the destination, to obtain a first determining result;

a navigation ending module, configured to end navigation when the first determining result is that the current location is consistent with the destination;

an optimal route planning module, configured to: when the first determining result is that the current location is inconsistent with the destination, automatically plan an optimal route from the current location to the destination according to the current location, the destination, and the QR code signpost map;

a destination signpost obtaining module, configured to: determine, according to the current location and the optimal route, that a next QR code signpost that the trolley is to go to is a destination signpost, obtain a signpost code of the destination signpost, and use the signpost code as a target code;

a camera image obtaining module, configured to obtain a current image captured by a trolley camera;

a QR code signpost detection module, configured to: detect a QR code signpost according to the current image, and determine, according to the target code, whether the QR code signpost is detected successfully, to obtain a second determining result;

a trolley direction adjustment module, configured to: if the second determining result is that the QR code signpost is detected successfully, adjust a direction of the trolley according to a relative location of the QR code signpost in the current image, so that the trolley faces the QR code signpost and goes forward;

a brightness information obtaining module, configured to: in a process in which the trolley goes forward, obtain brightness information captured by an infrared sensor installed under the trolley;

a brightness information determining module, configured to determine, according to the brightness information, whether the trolley reaches the QR code signpost, to obtain a fourth determining result;

a first returning module, configured to: if the fourth determining result is that the trolley reaches the QR code signpost, return to the step of obtaining a current location of a trolley and a destination specified by a user;

a second returning module, configured to: if the fourth determining result is that the trolley does not reach the QR code signpost, return to the step of adjusting a direction of the trolley according to a relative location of the QR code signpost in the current image, so that the trolley faces the QR code signpost and goes forward; and

an anomaly recovery decision module, configured to: if the second determining result is that the QR code signpost is detected unsuccessfully, determine, by using an anomaly recovery decision method, a manner in which the trolley goes forward.

Optionally, the optimal route planning module specifically includes:

a route search unit, configured to perform a depth-first search on the QR code signpost map, to determine a plurality of routes from the current location to the destination, and record a quantity of turns and a route distance that are of each route; and

an optimal route planning unit, configured to determine that a route in the plurality of routes that has a smallest quantity of turns and a shortest route distance is the optimal route.

Optionally, the QR code signpost detection module specifically includes:

a QR code signpost detection unit, configured to: detect the QR code signpost according to the current image, where if the QR code signpost exists in the current image, a signpost code of the QR code signpost can be detected, and the signpost code is consistent with the target code, it is determined that the second determining result is that the QR code signpost is detected successfully; or otherwise, it is determined that the second determining result is that the QR code signpost is detected unsuccessfully.

Optionally, the trolley direction adjustment module specifically includes:

a binarization processing unit, configured to perform binarization processing on the current image, to generate a binary image;

a contour detection processing unit, configured to perform contour detection processing on the binary image, to obtain a plurality of contours in the current image;

a polygonal approximation processing unit, configured to perform polygonal approximation processing on the plurality of contours, to obtain shapes of the plurality of contours;

a contour screening unit, configured to remove a non-quadrilateral contour in the plurality of contours according to the shapes of the contours, to obtain a plurality of quadrilateral contours;

a contour filtering unit, configured to filter the plurality of quadrilateral contours according to areas of the quadrilateral contours, to obtain a QR code signpost contour;

a signpost code scanning unit, configured to scan a QR code signpost in the QR code signpost contour, to obtain a signpost code of the QR code signpost;

a vertex location coordinate determining unit, configured to determine location coordinates of four vertices of the QR code signpost contour in the current image;

a unit for determining horizontal coordinates of a center of gravity, configured to determine horizontal coordinates of a center of gravity of the QR code signpost according to the location coordinates of the four vertices in the current image;

a unit for obtaining horizontal coordinates of an image center, configured to obtain horizontal coordinates of an image center of the current image; and

a first trolley direction adjustment unit, configured to adjust the direction of the trolley according to a relative location of the horizontal coordinates of the center of gravity of the QR code signpost to the horizontal coordinates of the image center, so that the trolley faces the QR code signpost and goes forward.

Optionally, the anomaly recovery decision module specifically includes:

a QR code signpost determining unit, configured to: detect a QR code signpost according to the current image, and determine whether a QR code signpost exists in the current image, to obtain a fifth determining result;

a heuristic search unit, configured to: if the fifth determining result is that no QR code signpost exists in the current image, control the trolley to go forward by searching a path in a zigzag in a heuristic manner, to find a nearby QR code signpost;

a signpost code recognition unit, configured to: if the fifth determining result is that a QR code signpost exists in the current image, determine whether a signpost code of the QR code signpost can be recognized, to obtain a sixth determining result;

a first returning unit, configured to: if the sixth determining result is that the signpost code of the QR code signpost cannot be recognized, return to the step of adjusting a direction of the trolley according to a relative location of the QR code signpost in the current image, so that the trolley faces the QR code signpost and goes forward;

a signpost code determining unit, configured to: if the sixth determining result is that the signpost code of the QR code signpost can be recognized, determine whether the signpost code is consistent with the target code, to obtain a seventh determining result;

a reserved chance determining unit, configured to: if the seventh determining result is that the signpost code is inconsistent with the target code, determine whether a reserved chance to correct an incorrect destination signpost is exhausted, to obtain an eighth determining result;

a second trolley direction adjustment module, configured to: if the eighth determining result is that the reserved chance to correct an incorrect destination signpost is not exhausted, adjust the direction of the trolley according to a location of the QR code signpost in the QR code signpost map, so that the trolley faces the destination signpost and goes forward; and

a second returning unit, configured to: if the eighth determining result is that the reserved chance to correct an incorrect destination signpost is exhausted, return to the step of adjusting a direction of the trolley according to a relative location of the QR code signpost in the current image, so that the trolley faces the QR code signpost and goes forward; and

a second determining result determining unit, configured to: if the seventh determining result is that the signpost code is consistent with the target code, determine that the second determining result is that the QR code signpost is detected successfully.

According to specific embodiments of the present disclosure, the present disclosure has the following technical effects:

The present disclosure discloses a visual navigation method and system for mobile devices based on QR code signposts. The method includes: autonomously planning an optimal route according to a destination specified by a user, performing positioning in an image captured by a trolley camera and recognizing signpost information, and adjusting a pose according to the signpost information and going to a destination signpost in the path. In this process, a trolley is positioned in real time and route planning are updated. The visual navigation method for movement disclosed in the present disclosure does not rely on a GPS signal and strong computation resources, but also can effectively meet an indoor scheduling scenario in which a path needs to be planned intelligently, to resolve a problem that in an existing indoor autonomous navigation method based on monocular vision and QR code signpost, a route cannot be autonomously planned, leading to a limited application scenario and high maintenance costs.

### BRIEF DESCRIPTION OF DRAWINGS

To describe the technical solutions in the embodiments of the present disclosure or in the prior art more clearly, the accompanying drawings required for describing the embodiments will be described briefly below. Apparently, the accompanying drawings in the following descriptions show some embodiments of the present disclosure, and a person of ordinary skill in the art may still derive other drawings from these accompanying drawings without creative efforts.

FIG. 1 is a flowchart of a visual navigation method for mobile devices based on QR code signposts according to the present disclosure;

FIG. 2 is a principle diagram of a visual navigation method for mobile devices based on QR code signposts according to the present disclosure;

FIG. 3 is a schematic diagram of a QR code signpost according to the present disclosure; and

FIG. 4 is a schematic diagram of a QR code signpost map according to the present disclosure.

### DETAILED DESCRIPTION

The following clearly and completely describes the technical solutions in the embodiments of the present disclosure with reference to accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The present disclosure aims to provide a visual navigation method and system for mobile devices based on QR code signposts, to resolve a problem that in an existing indoor autonomous navigation method based on monocular vision and QR code signpost, a route cannot be autonomously planned, leading to a limited application scenario and high maintenance costs.

To make the foregoing objective, features, and advantages of the present disclosure clearer and more comprehensible, the present disclosure is further described in detail below with reference to the accompanying drawings and specific implementations.

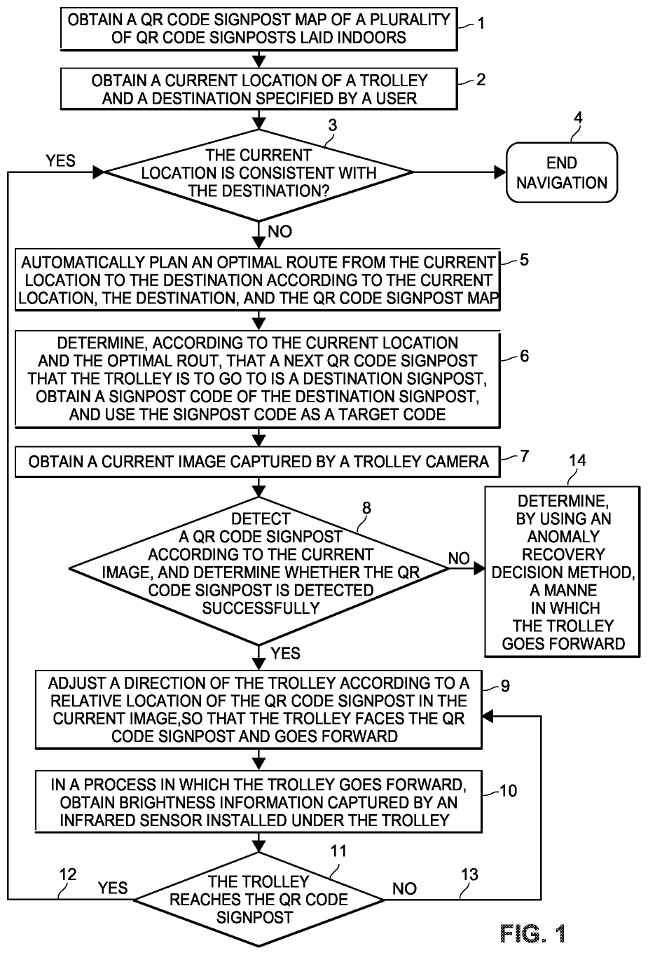

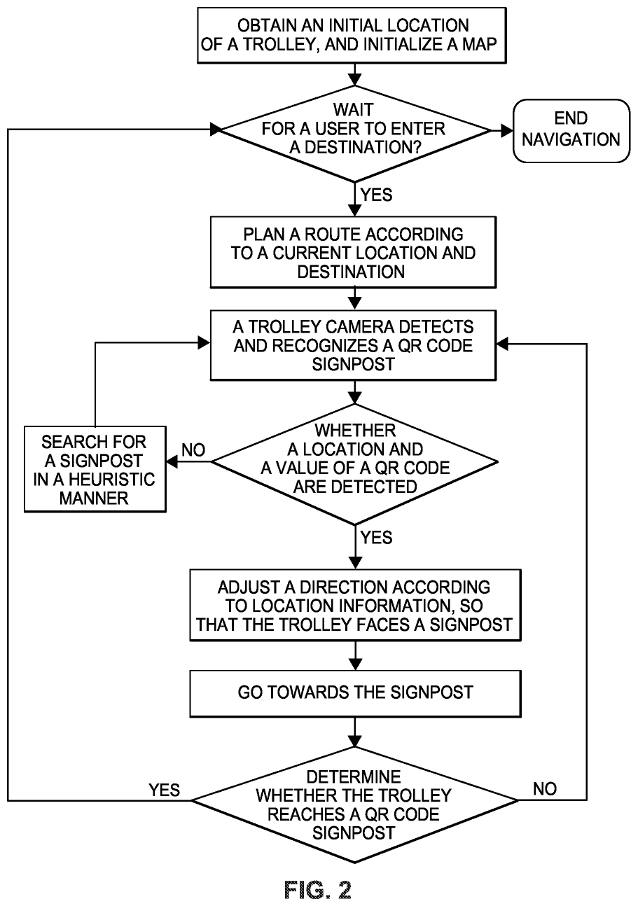

FIG. 1 is a flowchart of a visual navigation method for mobile devices based on QR code signposts according to the present disclosure. FIG. 2 is a principle diagram of a visual navigation method for mobile devices based on QR code signposts according to the present disclosure. As shown in FIG. 1 and FIG. 2, the visual navigation method for mobile devices based on QR code signposts provided in the present disclosure specifically includes:

Step 1: Obtain a QR code signpost map of a plurality of QR code signposts laid indoors.

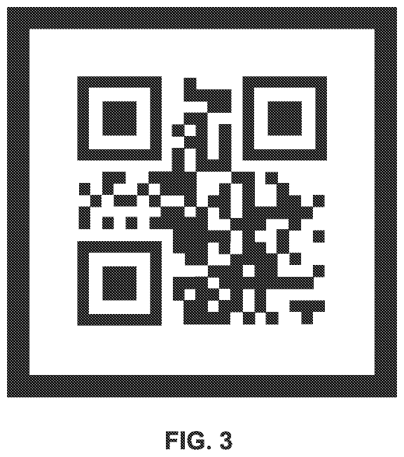

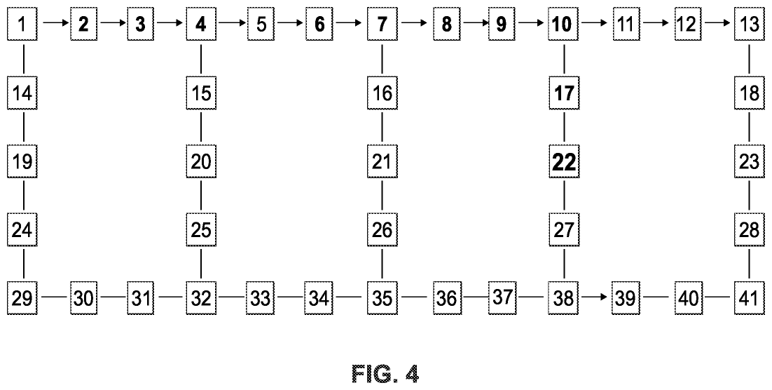

FIG. 3 is a schematic diagram of a QR code signpost according to the present disclosure. FIG. 4 is a schematic diagram of a QR code signpost map according to the present disclosure. As shown in FIG. 3 and FIG. 4, before the method in the present disclosure is applied, a QR code (QR code) needs to be laid in an indoor environment, and is used as a signpost. Considering that real building interiors are usually straight lines or right angles, and are occasionally rectangles, a map including signposts needs to be in a grid pattern. Each point that may be used as a start point, an end point, or a location reference is a feasible grid point. An equal distance between grid points does not need to be ensured, but it needs to be ensured that there exists a path between adjacent nodes on the map. When the map is initialized in the navigation system, coordinates of these feasible nodes and QR code signpost information (QR code content, that is, a signpost code) to be recognized by a trolley need to be provided.

Step 2: Obtain a current location of a trolley and a destination specified by a user.

As shown in FIG. 4, after the user selects a target location (the destination), a code 5 indicates the current location of the trolley, a code 22 indicates the target location of the trolley, a code 1 indicates a trolley start location, codes 2, 3, and 5 indicate a path through which the trolley goes in this trip, codes 6, 7, 8, 9, 10, and 17 indicate planned expected path, and an arrow is used to represent a driving direction.

Step 3: Determine whether the current location is consistent with the destination, to obtain a first determining result.

A current pose of the trolley (including the current location and a direction) is obtained, and an optimal route is automatically planned according to the current pose and the destination specified by the user. If the destination has been reached, navigation ends; or otherwise, the trolley returns to a next signpost in the path.

Step 4: End navigation if the first determining result is that the current location is consistent with the destination.

Step 5: If the first determining result is that the current location is inconsistent with the destination, automatically plan an optimal route from the current location to the destination according to the current location, the destination, and the QR code signpost map.

In the present disclosure, the trolley is installed with a control module, a camera module, an infrared sensor module, and a motion module. The control module is installed with a developed path planning algorithm and an image detection algorithm, to control and coordinate other modules. The camera module is configured to capture a visual image, to locate a signpost and navigate. The infrared sensor module is configured to detect brightness, to determine whether the trolley has reached the signpost. The motion module is configured to: move the trolley and adjust the pose of the trolley.

Step 5 may specifically include:

performing a depth-first search on the QR code signpost map, to determine a plurality of routes from the current location to the destination, and record a quantity of turns and a route distance that are of each route; and

determining that a route in the plurality of routes that has a smallest quantity of turns and a shortest route distance is the optimal route.

Step 6: Determine, according to the current location and the optimal route, that a next QR code signpost that the trolley is to go to is a destination signpost, obtain a signpost code of the destination signpost, and use the signpost code as a target code.

Step 7: Obtain a current image captured by a trolley camera.

The trolley captures the current image by using the camera module, determines a relative location of the next QR code signpost according to the image captured by the trolley camera, and adjusts the pose, so that the signpost is in a direction in which the trolley goes forward.

Step 8: Detect a QR code signpost according to the current image, and determine, according to the target code, whether the QR code signpost is detected successfully, to obtain a second determining result.

The image detection algorithm installed in the control module is used to perform a series of image processing such as binarization, contour detection, and polygonal approximation on the current image, to detect a QR code signpost in the image, correct a distorted QR code signpost in the image, and recognize QR code signpost information, so as to generate a signpost code of the QR code signpost and a location in the image.

Specifically, step 8 may include: detecting the QR code signpost according to the current image, where if the QR code signpost exists in the current image, a signpost code of the QR code signpost can be detected, and the signpost code is consistent with the target code, the second determining result is that the QR code signpost is detected successfully; or otherwise, the second determining result is that the QR code signpost is detected unsuccessfully.

Step 9: If the second determining result is that the QR code signpost is detected successfully, adjust a direction of the trolley according to a relative location of the QR code signpost in the current image, so that the trolley faces the QR code signpost and goes forward.

In the present disclosure, a monocular or binocular camera is supported. One frame of image captured by the camera module is read for subsequent processing. The subsequent processing is performing a series of image processing such as binarization, contour detection, and polygonal approximation on the image, to detect the QR code signpost in the image.

To improve accuracy rate of signpost detection in actual application, a black rectangle frame is added around the QR code signpost (referred to as a signpost for short) for easy recognition. To detect the signpost in the image, the current image is processed in the following steps:

(1) Perform Gaussian filtering and OSTU (Otsu's method) adaptive binarization: A QR code is black, and can usually be distinguished from an environment. Therefore, adaptive binarization is first performed, to make use of this feature.

(2) Perform contour detection.

(3) Perform polygonal approximation on a detected contour.

(4) Remove a non-quadrilateral contour: Only a contour that may be a rectangular frame of the signpost is retained.

(5) Filter out a too small or large contour according to an area surrounded by a quadrangle: A size of the signpost should be within a specific range in the image, and a candidate whose area is obviously too large or too small may be removed.

(6) Obtain four vertices of the signpost.

(7) Correct the distorted QR code signpost.

To improve a QR code recognition rate, a distorted QR code needs to be corrected. Processing based on the vertices of the signpost obtained in the previous step is performed in the following steps:

calculating a homography matrix by using the four vertices of the signpost in the image as corresponding points;

performing nomography transformation on the signpost in the original image according to the homography matrix; and

performing binarization on a transformed QR code.

(8) Recognize the QR code signpost information.

An integrated Python library pyzbar is used to perform recognition, to obtain a signpost code of the QR code signpost.

(9) Detect a location of the QR code signpost in the image.

After the four vertices of the signpost are obtained, a center of gravity of a quadrangle of the signpost in the image is calculated first, and then the location of the signpost is determined by using a relative position of the horizontal coordinate of the center of gravity to an image center. The pose of the trolley is repeatedly adjusted to the left or to the right according to a relative location of the horizontal coordinates of the center of gravity of the QR code signpost to the horizontal coordinates of the image center, so that the QR code signpost is right in front of the trolley.

Therefore, step 9 may specifically include:

performing binarization processing on the current image, to generate a binary image;

performing contour detection processing on the binary image, to obtain a plurality of contours in the current image;

performing polygonal approximation processing on the plurality of contours, to obtain shapes of the plurality of contours;

removing a non-quadrilateral contour in the plurality of contours according to the shapes of the contours, to obtain a plurality of quadrilateral contours;

filtering the plurality of quadrilateral contours according to areas of the quadrilateral contours, to obtain a QR code signpost contour;

scanning a QR code signpost in the QR code signpost contour, to obtain a signpost code of the QR code signpost;

determining location coordinates of four vertices of the QR code signpost contour in the current image;

determining horizontal coordinates of a center of gravity of the QR code signpost according to the location coordinates of the four vertices in the current image;

obtaining horizontal coordinates of an image center of the current image; and

adjusting the direction of the trolley according to a relative location of the horizontal coordinates of the center of gravity of the QR code signpost to the horizontal coordinates of the image center, so that the trolley faces the QR code signpost and goes forward.

The trolley is driven to go forward, and an infrared sensor under the trolley is used to determine whether the QR code signpost is reached. If the QR code signpost is reached, go to step 2 to update path planning; or otherwise, go to step 9 to continue to adjust the pose and go forward.

Step 10: In a process in which the trolley goes forward, obtain brightness information captured by an infrared sensor installed under the trolley.

The QR code is black, and is distinguishable from an ordinary environment in an aspect of brightness. Therefore, the infrared sensor installed under the trolley can be used to detect whether the QR code signpost is reached.

Step 11: Determine, according to the brightness information, whether the trolley reaches the QR code signpost, to obtain a fourth determining result.

Step 12: If the fourth determining result is that the trolley reaches the QR code signpost, return to the step of obtaining a current location of a trolley and a destination specified by a user.

In this way, the user can set the destination change the previously specified destination in any step during trolley running, and the system will update the destination and a planned route when going to step 2 next time. In a driving process, a current pose of the trolley is updated by the navigation system, a target location is entered by the user, and the navigation system records and displays all historical paths in one driving process. The trolley has two states: waiting for entering of the destination and driving towards the destination. After the destination is entered, the trolley changes to a driving state, and the trolley changes to a waiting state after reaching the destination. A path in which the trolley goes through from a waiting state to a next waiting state is regarded as a whole path.

Step 13: If the fourth determining result is that the trolley does not reach the QR code signpost, return to the step of adjusting a direction of the trolley according to a relative location of the QR code signpost in the current image, so that the trolley faces the QR code signpost and goes forward.

Step 14: If the second determining result is that the QR code signpost is detected unsuccessfully, determine, by using an anomaly recovery decision method, a manner in which the trolley goes forward.

The trolley makes an anomaly recovery decision when losing signpost positioning, and the system plans a new route adaptively after repositioning. Specifically, there are three cases in which the trolley loses fixed signpost positioning:

(1) The signpost is successfully positioned, but information cannot be recognized: It is assumed that the signpost is a signpost that the trolley needs to go to. The trolley continues to go forward, and the signpost is left for another time of recognition subsequently.

(2) The signpost is successfully positioned, and after recognition, it is found that the signpost is not on the planned route: A chance to correct an incorrect destination toad sign is reserved. If the chance is exhausted, the trolley goes to the signpost and updates the pose of the trolley to a currently recognized signpost, to replan the route.

(3) The signpost cannot be positioned: A nearby signpost is searched for in a zigzag in a heuristic manner.

In the first case, it indicates that the signpost is located in a field of view of the trolley, but there is a poor ambient light and location angle. Consequently, signpost content (signpost code) cannot be recognized according to a recognition algorithm. Because a rough location of the destination signpost that the trolley faces is adjusted in a previous step, the signpost that cannot be recognized currently is the destination signpost, and a step of recognizing the signpost is circularly performed for a plurality of times subsequently.

In the second case, it indicates that deviations accumulated during navigation is relatively large. Consequently, the trolley deviates from the planned route, and a signpost that does not belong to the planned route is recognized. In the present disclosure, a counter chance is specified. An initial value is set to 1 each time the trolley starts from the signpost. Each time a point that does not belong to the planned route is recognized, if chance is 1, the direction is adjusted, according to the recognized signpost and a signpost distribution on the map, to a direction in which the trolley faces the destination signpost, and in addition, chance is subtracted by 1; or if chance is 0, the recognized signpost is used as a current destination signpost, and a route is replanned, to complete subsequent navigation steps.

In the third case, it indicates that a distance between the trolley and the destination signpost is too large or too small. If no signpost is observed in a current moving process, a state is set to “far”; or otherwise, the state is set to “close”. In addition, a counter cnt is started. An initial value is set to 0 each time the trolley starts from the signpost. When cnt is an odd number less than 10, the trolley turns to the left, and cnt is increased by 1 each time a rotation angle is increased linearly. When cnt is an even number less than 10, the trolley turns to the right, and cnt is increased by 1 each time a rotation angle is increased linearly. When cnt is equal to 10, the counter is set to zero. If the state is “far”, the trolley goes forward by a distance, so that a distance between the trolley and the destination signpost is shortened; or otherwise, the trolley retreats by a distance, so that the field of view is wider, helping recognize the destination signpost. Therefore, searching for a nearby signpost in a zigzag in a heuristic manner is completed.

Therefore, step 14 may specifically include:

detecting a QR code signpost according to the current image, and determining whether a QR code signpost exists in the current image, to obtain a fifth determining result;

if the fifth determining result is that no QR code signpost exists in the current image, controlling the trolley to go forward by searching a path in a zigzag in a heuristic manner, to find a nearby QR code signpost;

if the fifth determining result is that a QR code signpost exists in the current image, determining whether a signpost code of the QR code signpost can be recognized, to obtain a sixth determining result;

returning to step 9 if the sixth determining result is that the signpost code of the QR code signpost cannot be recognized;

if the sixth determining result is that the signpost code of the QR code signpost can be recognized, determining whether the signpost code is consistent with the target code, to obtain a seventh determining result;

if the seventh determining result is that the signpost code is inconsistent with the target code, determining whether a reserved chance to correct an incorrect destination signpost is exhausted, to obtain an eighth determining result;

if the eighth determining result is that the reserved chance to correct an incorrect destination signpost is not exhausted, adjusting the direction of the trolley according to a location of the QR code signpost in the QR code signpost map, so that the trolley faces the destination signpost and goes forward; and

returning to the step 9 if the eighth determining result is that the reserved chance to correct an incorrect destination signpost is exhausted; and

if the seventh determining result is that the signpost code is consistent with the target code, determining that the second determining result is that the QR code signpost is detected successfully.

The visual navigation method for mobile devices based on QR code signposts provided in the present disclosure includes: autonomously planning an optimal route according to a destination specified by a user, performing positioning in an image captured by a trolley camera and recognizing signpost information, and adjusting a pose according to the signpost information and going to a signpost in the path. In this process, position is performed in real time and route planning is updated, and a user may change the destination at any time in a trolley navigation process according to a robust anomaly recovery decision. The method not only proposes an indoor navigation solution that does not rely on a GPS signal and strong computation resources, but also can effectively meet an indoor scheduling scenario in which a path needs to be planned intelligently.

Based on the visual navigation method for mobile devices based on QR code signposts in the present disclosure, the present disclosure further discloses a visual navigation system for mobile devices based on QR code signposts. The system includes:

a QR code signpost map obtaining module, configured to obtain a QR code signpost map of a plurality of QR code signposts laid indoors;

a location information obtaining module, configured to obtain a current location of a trolley and a destination specified by a user;

a location determining module, configured to determine whether the current location is consistent with the destination, to obtain a first determining result;

a navigation ending module, configured to end navigation when the first determining result is that the current location is consistent with the destination;

an optimal route planning module, configured to: when the first determining result is that the current location is inconsistent with the destination, automatically plan an optimal route from the current location to the destination according to the current location, the destination, and the QR code signpost map;

a destination signpost obtaining module, configured to: determine, according to the current location and the optimal route, that a next QR code signpost that the trolley is to go to is a destination signpost, obtain a signpost code of the destination signpost, and use the signpost code as a target code;

a camera image obtaining module, configured to obtain a current image captured by a trolley camera;

a QR code signpost detection module, configured to: detect a QR code signpost according to the current image, and determine, according to the target code, whether the QR code signpost is detected successfully, to obtain a second determining result;

a trolley direction adjustment module, configured to: if the second determining result is that the QR code signpost is detected successfully, adjust a direction of the trolley according to a relative location of the QR code signpost in the current image, so that the trolley faces the QR code signpost and goes forward;

a brightness information obtaining module, configured to: in a process in which the trolley goes forward, obtain brightness information captured by an infrared sensor installed under the trolley;

a brightness information determining module, configured to determine, according to the brightness information, whether the trolley reaches the QR code signpost, to obtain a fourth determining result;

a first returning module, configured to: if the fourth determining result is that the trolley reaches the QR code signpost, return to the step of obtaining a current location of a trolley and a destination specified by a user;

a second returning module, configured to: if the fourth determining result is that the trolley does not reach the QR code signpost, return to the step of adjusting a direction of the trolley according to a relative location of the QR code signpost in the current image, so that the trolley faces the QR code signpost and goes forward; and

an anomaly recovery decision module, configured to: if the second determining result is that the QR code signpost is detected unsuccessfully, determine, by using an anomaly recovery decision method, a manner in which the trolley goes forward.

The optimal route planning module specifically includes:

a route search unit, configured to perform a depth-first search on the QR code signpost map, to determine a plurality of routes from the current location to the destination, and record a quantity of turns and a route distance that are of each route; and

an optimal route planning unit, configured to determine that a route in the plurality of routes that has a smallest quantity of turns and a shortest route distance is the optimal route.

The QR code signpost detection module specifically includes:

a QR code signpost detection unit, configured to: detect the QR code signpost according to the current image, where if the QR code signpost exists in the current image, a signpost code of the QR code signpost can be detected, and the signpost code is consistent with the target code, it is determined that the second determining result is that the QR code signpost is detected successfully; or otherwise, it is determined that the second determining result is that the QR code signpost is detected unsuccessfully.

The trolley direction adjustment module specifically includes:

a binarization processing unit, configured to perform binarization processing on the current image, to generate a binary image;

a contour detection processing unit, configured to perform contour detection processing on the binary image, to obtain a plurality of contours in the current image;

a polygonal approximation processing unit, configured to perform polygonal approximation processing on the plurality of contours, to obtain shapes of the plurality of contours;

a contour screening unit, configured to remove a non-quadrilateral contour in the plurality of contours according to the shapes of the contours, to obtain a plurality of quadrilateral contours;

a contour filtering unit, configured to filter the plurality of quadrilateral contours according to areas of the quadrilateral contours, to obtain a QR code signpost contour;

a signpost code scanning unit, configured to scan a QR code signpost in the QR code signpost contour, to obtain a signpost code of the QR code signpost;

a vertex location coordinate determining unit, configured to determine location coordinates of four vertices of the QR code signpost contour in the current image;

a unit for determining horizontal coordinates of a center of gravity, configured to determine horizontal coordinates of a center of gravity of the QR code signpost according to the location coordinates of the four vertices in the current image;

a unit for obtaining horizontal coordinates of an image center, configured to obtain horizontal coordinates of an image center of the current image; and

a first trolley direction adjustment unit, configured to adjust the direction of the trolley according to a relative location of the horizontal coordinates of the center of gravity of the QR code signpost to the horizontal coordinates of the image center, so that the trolley faces the QR code signpost and goes forward.

The anomaly recovery decision module specifically includes:

a QR code signpost determining unit, configured to: detect a QR code signpost according to the current image, and determine whether a QR code signpost exists in the current image, to obtain a fifth determining result;

a heuristic search unit, configured to: if the fifth determining result is that no QR code signpost exists in the current image, control the trolley to go forward by searching a path in a zigzag in a heuristic manner, to find a nearby QR code signpost;

a signpost code recognition unit, configured to: if the fifth determining result is that a QR code signpost exists in the current image, determine whether a signpost code of the QR code signpost can be recognized, to obtain a sixth determining result;

a first returning unit, configured to: if the sixth determining result is that the signpost code of the QR code signpost cannot be recognized, return to the step of adjusting a direction of the trolley according to a relative location of the QR code signpost in the current image, so that the trolley faces the QR code signpost and goes forward;

a signpost code determining unit, configured to: if the sixth determining result is that the signpost code of the QR code signpost can be recognized, determine whether the signpost code is consistent with the target code, to obtain a seventh determining result;

a reserved chance determining unit, configured to: if the seventh determining result is that the signpost code is inconsistent with the target code, determine whether a reserved chance to correct an incorrect destination signpost is exhausted, to obtain an eighth determining result;

a second trolley direction adjustment module, configured to: if the eighth determining result is that the reserved chance to correct an incorrect destination signpost is not exhausted, adjust the direction of the trolley according to a location of the QR code signpost in the QR code signpost map, so that the trolley faces the destination signpost and goes forward; and

a second returning unit, configured to: if the eighth determining result is that the reserved chance to correct an incorrect destination signpost is exhausted, return to the step of adjusting a direction of the trolley according to a relative location of the QR code signpost in the current image, so that the trolley faces the QR code signpost and goes forward; and

a second determining result determining unit, configured to: if the seventh determining result is that the signpost code is consistent with the target code, determine that the second determining result is that the QR code signpost is detected successfully.

In the visual navigation method for mobile devices based on QR code signposts provided in the present disclosure, a location and a map of the trolley is initialized first. The user is waited to enter the destination. The route is planned according to the current location and the destination. The trolley camera performs detection, to recognize the QR code signpost. If detection is successfully performed, the direction is adjusted according to location information, so that the trolley faces the signpost and goes forward. This process is repeated until the trolley reaches the destination. If detection fails, an anomaly recovery decision is made, to perform repositioning through a heuristic search. The visual navigation method and system for mobile devices based on QR code signposts provided in the present disclosure includes: autonomously planning an optimal route according to a destination specified by a user, performing positioning in an image captured by a trolley camera and recognizing signpost information, and adjusting a pose according to the signpost information and going to a signpost in the path. In this process, position is performed in real time and route planning is updated, and a user may change the destination at any time in a trolley navigation process according to a robust anomaly recovery decision. The method not only proposes an indoor navigation solution that does not rely on a GPS signal and strong computation resources, but also can effectively meet an indoor scheduling scenario in which a path needs to be planned intelligently, to resolve a problem that in an existing indoor autonomous navigation method based on monocular vision and QR code signpost, a route cannot be autonomously planned, leading to a limited application scenario and high maintenance costs.

Each embodiment of this specification is described in a progressive manner. Each embodiment focuses on the difference from other embodiments. For the same and similar parts between the embodiments, refer to each other. For a system disclosed in the embodiments, since the system corresponds to the method disclosed in the embodiments, the description is relatively simple, and reference can be made to the method description.

In this specification, specific examples are used to describe the principles and implementations of the present disclosure. The description of the foregoing embodiments is used to help illustrate the method of the present disclosure and the core idea thereof. In addition, a person of ordinary skill in the art can make various modifications in terms of specific implementations and scope of application in accordance with the ideas of the present disclosure. In conclusion, the content of this specification shall not be construed as a limitation to the present disclosure.

What is claimed is:

1. A visual navigation method for mobile devices based on QR code signposts, wherein the method comprises:
obtaining a QR code signpost map of a plurality of QR code signposts laid indoors;
obtaining a current location of a trolley and a destination specified by a user;
determining whether the current location is consistent with the destination, to obtain a first determining result;
ending navigation if the first determining result is that the current location is consistent with the destination;
if the first determining result is that the current location is inconsistent with the destination, automatically planning an optimal route from the current location to the destination according to the current location, the destination, and the QR code signpost map;
determining, according to the current location and the optimal route, that a next QR code signpost that the trolley is to go to is a destination signpost, obtaining a signpost code of the destination signpost, and using the signpost code as a target code;
obtaining a current image captured by a trolley camera;
detecting a QR code signpost according to the current image, and determining, according to the target code, whether the QR code signpost is detected successfully, to obtain a second determining result;
if the second determining result is that the QR code signpost is detected successfully, adjusting a direction of the trolley according to a relative location of the QR code signpost in the current image, so that the trolley faces the QR code signpost and goes forward;
in a process in which the trolley goes forward, obtaining brightness information captured by an infrared sensor installed under the trolley;
determining, according to the brightness information, whether the trolley reaches the QR code signpost, to obtain a fourth determining result;
if the fourth determining result is that the trolley reaches the QR code signpost, returning to the step of obtaining a current location of a trolley and a destination specified by a user;
if the fourth determining result is that the trolley does not reach the QR code signpost, returning to the step of adjusting a direction of the trolley according to a relative location of the QR code signpost in the current image, so that the trolley faces the QR code signpost and goes forward; and
if the second determining result is that the QR code signpost is detected unsuccessfully, determining, by using an anomaly recovery decision method, a manner in which the trolley goes forward.

2. The visual navigation method for movement according to claim 1, wherein the automatically planning an optimal route from the current location to the destination according to the current location, the destination, and the QR code signpost map specifically comprises:
performing a depth-first search on the QR code signpost map, to determine a plurality of routes from the current location to the destination, and record a quantity of turns and a route distance that are of each route; and
determining that a route in the plurality of routes that has a smallest quantity of turns and a shortest route distance is the optimal route.

3. The visual navigation method for movement according to claim 2, wherein the detecting a QR code signpost according to the current image, and determining, according to the target code, whether the QR code signpost is detected successfully, to obtain a second determining result specifically comprises:
detecting the QR code signpost according to the current image, wherein if the QR code signpost exists in the current image, a signpost code of the QR code signpost can be detected, and the signpost code is consistent with the target code, the second determining result is that the QR code signpost is detected successfully; or otherwise, the second determining result is that the QR code signpost is detected unsuccessfully.

4. The visual navigation method for movement according to claim 3, wherein the adjusting a direction of the trolley according to a relative location of the QR code signpost in the current image, so that the trolley faces the QR code signpost and goes forward specifically comprises:
performing binarization processing on the current image, to generate a binary image;
performing contour detection processing on the binary image, to obtain a plurality of contours in the current image;
performing polygonal approximation processing on the plurality of contours, to obtain shapes of the plurality of contours;
removing a non-quadrilateral contour in the plurality of contours according to the shapes of the contours, to obtain a plurality of quadrilateral contours;
filtering the plurality of quadrilateral contours according to areas of the quadrilateral contours, to obtain a QR code signpost contour;
scanning a QR code signpost in the QR code signpost contour, to obtain a signpost code of the QR code signpost;
determining location coordinates of four vertices of the QR code signpost contour in the current image;
determining horizontal coordinates of a center of gravity of the QR code signpost according to the location coordinates of the four vertices in the current image;
obtaining horizontal coordinates of an image center of the current image; and
adjusting the direction of the trolley according to a relative location of the horizontal coordinates of the center of gravity of the QR code signpost to the horizontal coordinates of the image center, so that the trolley faces the QR code signpost and goes forward.

5. The visual navigation method for movement according to claim 4, wherein the determining, by using an anomaly recovery decision method, a manner in which the trolley goes forward specifically comprises:
detecting a QR code signpost according to the current image, and determining whether a QR code signpost exists in the current image, to obtain a fifth determining result;
if the fifth determining result is that no QR code signpost exists in the current image, controlling the trolley to go forward by searching a path in a zigzag in a heuristic manner, to find a nearby QR code signpost;
if the fifth determining result is that a QR code signpost exists in the current image, determining whether a signpost code of the QR code signpost can be recognized, to obtain a sixth determining result;
if the sixth determining result is that the signpost code of the QR code signpost cannot be recognized, returning to the step of adjusting a direction of the trolley according to a relative location of the QR code signpost in the current image, so that the trolley faces the QR code signpost and goes forward;
if the sixth determining result is that the signpost code of the QR code signpost can be recognized, determining whether the signpost code is consistent with the target code, to obtain a seventh determining result;
if the seventh determining result is that the signpost code is inconsistent with the target code, determining whether a reserved chance to correct an incorrect destination signpost is exhausted, to obtain an eighth determining result;
if the eighth determining result is that the reserved chance to correct an incorrect destination signpost is not exhausted, adjusting the direction of the trolley according to a location of the QR code signpost in the QR code signpost map, so that the trolley faces the destination signpost and goes forward; and
if the eighth determining result is that the reserved chance to correct an incorrect destination signpost is exhausted, returning to the step of adjusting a direction of the trolley according to a relative location of the QR code signpost in the current image, so that the trolley faces the QR code signpost and goes forward; and
if the seventh determining result is that the signpost code is consistent with the target code, determining that the second determining result is that the QR code signpost is detected successfully.

6. A visual navigation system for mobile devices based on QR code signposts, wherein the system comprises:
a QR code signpost map obtaining module, configured to obtain a QR code signpost map of a plurality of QR code signposts laid indoors;
a location information obtaining module, configured to obtain a current location of a trolley and a destination specified by a user;
a location determining module, configured to determine whether the current location is consistent with the destination, to obtain a first determining result;
a navigation ending module, configured to end navigation when the first determining result is that the current location is consistent with the destination;
an optimal route planning module, configured to: when the first determining result is that the current location is inconsistent with the destination, automatically plan an optimal route from the current location to the destination according to the current location, the destination, and the QR code signpost map;
a destination signpost obtaining module, configured to: determine, according to the current location and the optimal route, that a next QR code signpost that the trolley is to go to is a destination signpost, obtain a signpost code of the destination signpost, and use the signpost code as a target code;
a camera image obtaining module, configured to obtain a current image captured by a trolley camera;
a QR code signpost detection module, configured to: detect a QR code signpost according to the current image, and determine, according to the target code, whether the QR code signpost is detected successfully, to obtain a second determining result;
a trolley direction adjustment module, configured to: if the second determining result is that the QR code signpost is detected successfully, adjust a direction of the trolley according to a relative location of the QR code signpost in the current image, so that the trolley faces the QR code signpost and goes forward;
a brightness information obtaining module, configured to: in a process in which the trolley goes forward, obtain brightness information captured by an infrared sensor installed under the trolley;
a brightness information determining module, configured to determine, according to the brightness information, whether the trolley reaches the QR code signpost, to obtain a fourth determining result;
a first returning module, configured to: if the fourth determining result is that the trolley reaches the QR code signpost, return to the step of obtaining a current location of a trolley and a destination specified by a user;
a second returning module, configured to: if the fourth determining result is that the trolley does not reach the QR code signpost, return to the step of adjusting a direction of the trolley according to a relative location of the QR code signpost in the current image, so that the trolley faces the QR code signpost and goes forward; and
an anomaly recovery decision module, configured to: if the second determining result is that the QR code signpost is detected unsuccessfully, determine, by using an anomaly recovery decision method, a manner in which the trolley goes forward.

7. The visual navigation system for movement according to claim 6, wherein the optimal route planning module specifically comprises:
a route search unit, configured to perform a depth-first search on the QR code signpost map, to determine a plurality of routes from the current location to the destination, and record a quantity of turns and a route distance that are of each route; and
an optimal route planning unit, configured to determine that a route in the plurality of routes that has a smallest quantity of turns and a shortest route distance is the optimal route.

8. The visual navigation system for movement according to claim 7, wherein the QR code signpost detection module specifically comprises:
a QR code signpost detection unit, configured to: detect the QR code signpost according to the current image, wherein if the QR code signpost exists in the current image, a signpost code of the QR code signpost can be detected, and the signpost code is consistent with the target code, it is determined that the second determining result is that the QR code signpost is detected successfully; or otherwise, it is determined that the second determining result is that the QR code signpost is detected unsuccessfully.

9. The visual navigation system for movement according to claim 8, wherein the trolley direction adjustment module specifically comprises:
a binarization processing unit, configured to perform binarization processing on the current image, to generate a binary image;
a contour detection processing unit, configured to perform contour detection processing on the binary image, to obtain a plurality of contours in the current image;
a polygonal approximation processing unit, configured to perform polygonal approximation processing on the plurality of contours, to obtain shapes of the plurality of contours;
a contour screening unit, configured to remove a non-quadrilateral contour in the plurality of contours according to the shapes of the contours, to obtain a plurality of quadrilateral contours;
a contour filtering unit, configured to filter the plurality of quadrilateral contours according to areas of the quadrilateral contours, to obtain a QR code signpost contour;
a signpost code scanning unit, configured to scan a QR code signpost in the QR code signpost contour, to obtain a signpost code of the QR code signpost;
a vertex location coordinate determining unit, configured to determine location coordinates of four vertices of the QR code signpost contour in the current image;
a unit for determining horizontal coordinates of a center of gravity, configured to determine horizontal coordinates of a center of gravity of the QR code signpost according to the location coordinates of the four vertices in the current image;
a unit for obtaining horizontal coordinates of an image center, configured to obtain horizontal coordinates of an image center of the current image; and
a first trolley direction adjustment unit, configured to adjust the direction of the trolley according to a relative location of the horizontal coordinates of the center of gravity of the QR code signpost to the horizontal coordinates of the image center, so that the trolley faces the QR code signpost and goes forward.

10. The visual navigation system for movement according to claim 9, wherein the anomaly recovery decision module specifically comprises:
a QR code signpost determining unit, configured to: detect a QR code signpost according to the current image, and determine whether a QR code signpost exists in the current image, to obtain a fifth determining result;
a heuristic search unit, configured to: if the fifth determining result is that no QR code signpost exists in the current image, control the trolley to go forward by searching a path in a zigzag in a heuristic manner, to find a nearby QR code signpost;
a signpost code recognition unit, configured to: if the fifth determining result is that a QR code signpost exists in the current image, determine whether a signpost code of the QR code signpost can be recognized, to obtain a sixth determining result;
a first returning unit, configured to: if the sixth determining result is that the signpost code of the QR code signpost cannot be recognized, return to the step of adjusting a direction of the trolley according to a relative location of the QR code signpost in the current image, so that the trolley faces the QR code signpost and goes forward;
a signpost code determining unit, configured to: if the sixth determining result is that the signpost code of the QR code signpost can be recognized, determine whether the signpost code is consistent with the target code, to obtain a seventh determining result;
a reserved chance determining unit, configured to: if the seventh determining result is that the signpost code is inconsistent with the target code, determine whether a reserved chance to correct an incorrect destination signpost is exhausted, to obtain an eighth determining result;
a second trolley direction adjustment module, configured to: if the eighth determining result is that the reserved chance to correct an incorrect destination signpost is not exhausted, adjust the direction of the trolley according to a location of the QR code signpost in the QR code signpost map, so that the trolley faces the destination signpost and goes forward; and
a second returning unit, configured to: if the eighth determining result is that the reserved chance to correct an incorrect destination signpost is exhausted, return to the step of adjusting a direction of the trolley according to a relative location of the QR code signpost in the current image, so that the trolley faces the QR code signpost and goes forward; and
a second determining result determining unit, configured to: if the seventh determining result is that the signpost code is consistent with the target code, determine that the second determining result is that the QR code signpost is detected successfully.
